(19) United States
(12) Patent Application Publication
(10) Pub. No.: US 2025/0363341 A1
(43) Pub. Date: Nov. 27, 2025

(54) SYSTEMS AND METHODS FOR DYNAMIC ADJUSTMENTS USING SUPER ELASTICITY

(71) Applicant: Walmart Apollo, LLC, Bentonville, AR (US)

(72) Inventors: Young Seung Yoon, Los Altos, CA (US); Yuetong Zhou, Sunnyvale, CA (US); Parveen Kumar, Haryana (IN); Hengchao Wang, Bellevue, WA (US); Yuan Wang, San Francisco, CA (US); Lijie Wan, Mountain View, CA (US); Jing Huang, San Jose, CA (US); Mingang Fu, Palo Alto, CA (US); Himanshu Gupta, East Palo Alto, CA (US); Mohit Agarwal, Fremont, CA (US); Francisco Javier Medina, San Francisco, CA (US)

(21) Appl. No.: 18/674,162

(22) Filed: May 24, 2024

(51) Int. Cl. G06N 3/0499; G06N 3/084

(52) U.S. Cl. CPC G06N 3/0499; G06N 3/084

(57) ABSTRACT

Systems and methods of improved computer operation for optimizing feature values associated with a network application are disclosed. A set of weights for at least one offer associated with the network application is generated. A feature reduction goal for a first feature is obtained and a base feature value of the first feature for the at least one offer is received. A trained optimized feature value model is applied to determine a feature adjustment for the base feature value based at least in part on the feature reduction goal. The feature adjustment and the feature reduction goal are different. The feature adjustment is applied to the base feature value to generate an optimized feature value and the offer including the optimized feature value is transmitted to at least one user device associated with the network application.

### TECHNICAL FIELD

This application relates generally to dynamically adjusting feature values in a network platform, and more particularly, to dynamically determining a feature value based on minimum detectable effects.

### BACKGROUND

Network platforms may rely on one or more feature values to drive interaction and engagement with the platform. The network platform may present a feature value for specific activities facilitated by and/or executed in conjunction with the network platform. For example, in the context of a last mile delivery network platform, feature values may include pricing values for available deliveries or other last mile delivery related activities. Feature values may be selected to maximize one or more network platform operations, such as engagement or acceptance rates.

Some current network platforms rely on a feature setting process that includes a base feature value, e.g., a base price, and a surge feature value, e.g., a surge price. The base feature value is provided as an initial or baseline value that is expected to drive engagement (e.g., acceptance) on the network platform. A surge feature value may be provided to cause engagement with network offerings when a base feature value is insufficient to cause engagement. Although these systems are able to make some adjustment to a feature value, the adjustments are based on predetermined, estimated base feature values, which may be over- and/or under-valued.

### SUMMARY

In various embodiments, a system is disclosed. The system includes a non-transitory memory and a processor communicatively coupled to the non-transitory memory. The processor is configured to read a set of instructions to generate a set of weights for at least one offer associated with a network application, obtain a feature reduction goal for a first feature, receive a base feature value of the first feature for the at least one offer, and apply a trained optimized feature value model to determine a feature adjustment for the base feature value based at least in part on the feature reduction goal. The feature adjustment and the feature reduction goal are different. The processor is further configured to read the set of instructions to apply the feature adjustment to the base feature value to generate an optimized feature value and transmit the offer including the optimized feature value to at least one user device.

In various embodiments, a computer-implemented method is disclosed. The computer-implemented method includes steps of generating a set of weights for at least one offer associated with a network application, obtaining a feature reduction goal for a first feature, receiving a base feature value of the first feature for the at least one offer, and applying a trained optimized feature value model to determine a feature adjustment for the base feature value based at least in part on the feature reduction goal. The feature adjustment and the feature reduction goal are different. The computer-implemented method further includes steps of applying the feature adjustment to the base feature value to generate an optimized feature value and transmitting the offer including the optimized feature value to at least one user device.

In various embodiments, a non-transitory computer readable medium having instructions stored thereon is disclosed. The instructions, when executed by at least one processor, cause at least one device to perform operations including generating a set of weights for a first offer in a plurality of offers associated with a network application, obtaining a feature reduction goal for a first feature, receiving a base feature value of the first feature for the first offer, and applying a trained optimized feature value model to determine a feature adjustment for the base feature value based at least in part on the feature reduction goal. An average of the feature adjustment for each offer in the plurality of offers is equal to the feature reduction goal. The instructions further cause the at least one device to perform operations including applying the feature adjustment to the base feature value to generate an optimized feature value and transmitting the offer including the optimized feature value to at least one user device.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a network environment configured to provide dynamic feature value adjustments for a network application, in accordance with some embodiments;

FIG. 2 illustrates a computer system configured to implement one or more processes, in accordance with some embodiments;

FIG. 3 is a flowchart illustrating a network application flow, in accordance with some embodiments;

FIG. 4 is a flowchart illustrating a dynamic feature adjustment method, in accordance with some embodiments;

FIG. 5 is a process flow illustrating various steps of the dynamic feature adjustment method of FIG. 4, in accordance with some embodiments;

FIG. 6 illustrates equations representative of one or more operations or sub-operations performed by one or more models, engines, systems, devices, etc. disclosed herein, in accordance with some embodiments;

FIG. 7 illustrates an artificial neural network, in accordance with some embodiments;

FIG. 8 illustrates a deep neural network (DNN), in accordance with some embodiments;

FIG. 9 illustrates various equations representative of one or more operations or sub-operations performed by and/or in conjunction with one or more networks illustrated in FIG. 7 or 8, in accordance with some embodiments;

FIG. 10 is a flowchart illustrating a training method for generating a trained machine learning model, in accordance with some embodiments; and

FIG. 11 is a process flow illustrating various steps of the training method of FIG. 10, in accordance with some embodiments.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

Furthermore, in the following, various embodiments are described with respect to methods and systems for operating a network application including dynamic adjustment of one or more feature values to approach optimal feature values. In various embodiments, a network platform is configured to train a dynamic value model configured to apply dynamic adjustments to a predetermined feature value associated with an offering of the network platform. As one non-limiting example, the network platform may include a last mile delivery platform and the predetermined feature value may include a pricing value associated with a delivery trip offered by the last mile delivery platform. The dynamic value model is configured to determine an optimized base line feature value for the selected offering. The optimized base line feature value may be presented with the offering and/or used as an initial feature value for applying one or more additional adjustments, such as one or more surge adjustments.

In some embodiments, systems, and methods for dynamic determination of feature values within a network environment includes one or more trained optimal feature models. The trained optimization may include one or more models, such as one or more trained two-layer models configured to generate a set of parameters in a first layer and generate an optimized multiplier in a second layer. In some embodiments, the multiplier is applied to a base line feature value to generate an optimized feature value.

In general, a trained function mimics cognitive functions that humans associate with other human minds. In particular, by training based on training data the trained function is able to adapt to new circumstances and to detect and extrapolate patterns.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

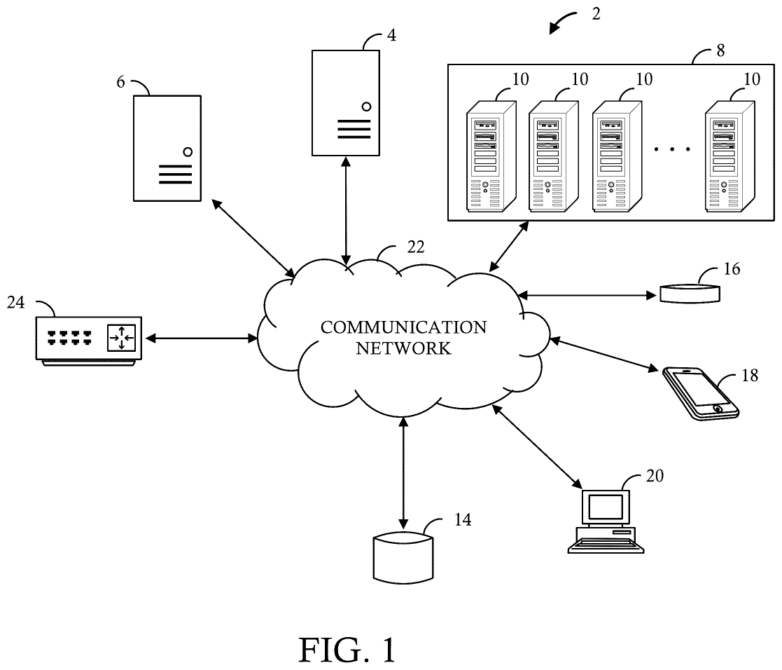

FIG. 1 illustrates a network environment 2 configured to provide dynamic feature value adjustments for a network application, in accordance with some embodiments. The network environment 2 includes a plurality of devices or systems configured to communicate over one or more network channels, illustrated as a network cloud 22. For example, in various embodiments, the network environment 2 may include, but is not limited to, a dynamic adjustment computing device 4, a web server 6, a cloud-based engine 8 including one or more processing devices 10, a database 14, and/or one or more user computing devices 16, 18, 20 operatively coupled over the network 22. The dynamic adjustment computing device 4, the web server 6, the processing device(s) 10, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the dynamic adjustment computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the dynamic adjustment computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments or applications, such as an e-commerce network environment or application. In some embodiments, the dynamic adjustment computing device 4, the processing devices 10, and/or the web server 6 are operated by the network environment provider, and the user computing devices 16, 18, 20 are operated by users of the network environment. In some embodiments, the processing devices 10 are operated by a third party (e.g., a cloud-computing provider).

Although FIG. 1 illustrates three user computing devices 16, 18, 20, the network environment 2 may include any number of user computing devices 16, 18, 20. Similarly, the network environment 2 may include any number of the dynamic adjustment computing device 4, the web server 6, the processing devices 10, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the dynamic adjustment computing device 4, the web server 6, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, 20 may communicate with the web server 6 over the communication network 22. For example, each of the user computing devices 16, 18, 20 may be operable to view, access, and interact with a web-based network application, such as an e-commerce network application, hosted by the web server 6. The web server 6 may transmit user session data related to a user's activity (e.g., interactions) on the application. For example, a user may operate one of the user computing devices 16, 18, 20 to initiate a web browser that is directed to the website hosted by the web server 6. The user may, via the web browser, perform various operations such as identifying available operations, selecting one or more offerings, providing availability information, etc. The web application may capture these activities as user session data, and transmit the user session data to the dynamic adjustment computing device 4 over the communication network 22. The web application may also allow the user to interact with one or more of interface elements to perform specific operations, such as selecting one or more offerings for completion.

In some embodiments, the dynamic adjustment computing device 4 may execute one or more models, processes, or algorithms, such as a machine learning model, deep learning model, statistical model, etc., to optimize one or more feature values. The dynamic adjustment computing device 4 may transmit optimized feature values and/or data elements including optimized feature values to the web server 6 over the communication network 22, and the web server 6 may display interface elements associated with optimized feature values on the web application interface to the user.

In some embodiments, the web application includes a last-mile delivery application. The last-mile delivery application presents one or more last-mile deliveries (e.g., deliveries from final distribution centers and/or retail locations to residential addresses) that may be selected and completed by one or more users. The last-mile delivery application may present one or more offerings, e.g., available deliveries, and information associated with the one or more offerings, such as current price/offer amount, distance to travel, goods to be delivered, etc. A user interacting with the last-mile delivery application determines whether a currently offered price is sufficient to induce acceptance and completion of an available offering. The last-mile delivery application may be configured to adjust one or more features, such as a price feature, of an offering to increase a likelihood of acceptance. In some embodiments, a last-mile delivery application (or any other suitable web application) may utilize a plurality of feature values and/or adjustments, such as, for example, an initial base feature value, one or more surge feature values and/or increments, one or more incentive values, etc., to increase likelihood of acceptance of one or more offerings.

The dynamic adjustment computing device 4 is further operable to communicate with the database 14 over the communication network 22. For example, the dynamic adjustment computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the dynamic adjustment computing device 4, in some embodiments, the database 14 may be a local storage device, such as a hard drive, a non-volatile memory, or a USB stick. The dynamic adjustment computing device 4 may store interaction data received from the web server 6 in the database 14. The dynamic adjustment computing device 4 may also receive from the web server 6 user session data identifying events associated with browsing sessions, and may store the user session data in the database 14.

In some embodiments, the dynamic adjustment computing device 4 generates training data for a plurality of models (e.g., machine learning models, deep learning models, statistical models, algorithms, etc.) based on historical data such as interaction data, acceptance rates, feature values, etc. The dynamic adjustment computing device 4 and/or one or more of the processing devices 10 may train one or more models based on corresponding training data. The dynamic adjustment computing device 4 may store the models in a database, such as in the database 14 (e.g., a cloud storage database).

The models, when executed by the dynamic adjustment computing device 4, allow the dynamic adjustment computing device 4 to generate optimized feature values, such as optimized base feature values and/or optimized incremental feature values. For example, the dynamic adjustment computing device 4 may obtain one or more models from the database 14. The dynamic adjustment computing device 4 may then receive, in real-time from the web server 6, a request for a base feature value and/or incremental feature value. In response to receiving the request, the dynamic adjustment computing device 4 may execute one or more models to generate a minimal acceptable base feature value and/or minimal acceptable incremental feature values for a corresponding base feature value. The one or more models may be configured to utilize supply elasticity to determine feature value adjustments. In some embodiments, the one or more models include at least one multiplier generation algorithm configured to apply an average reduction goal for the base feature value across a plurality of slots and/or applications of a feature value.

In some embodiments, the dynamic adjustment computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, dynamic adjustment computing device 4 may generate base feature values and/or incremental adjustment values for one or more slots utilizing the corresponding feature value.

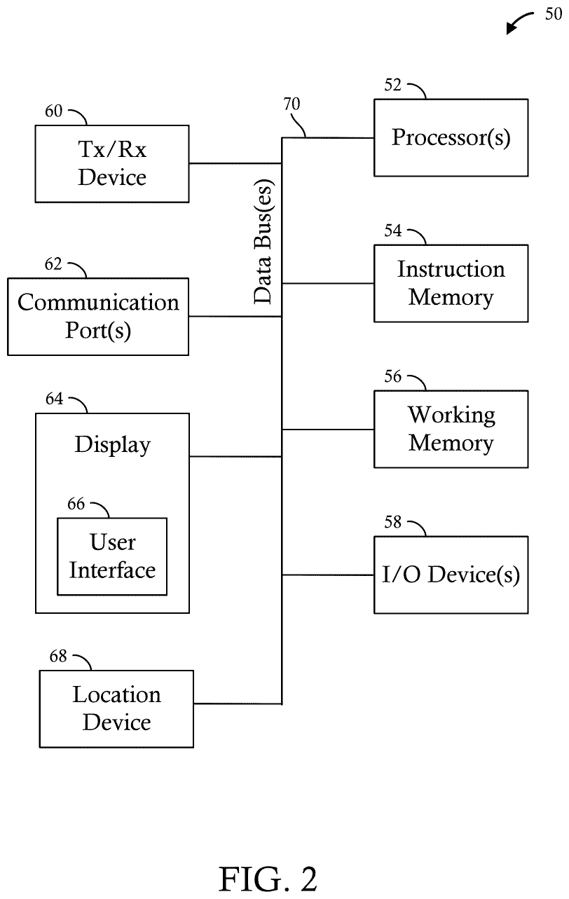

FIG. 2 illustrates a block diagram of a computing device 50, in accordance with some embodiments. In some embodiments, each of the dynamic adjustment computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may be configured to perform a certain function or operation by executing code, stored on the instruction memory 54, embodying the function or operation. For example, the one or more processors 52 may be configured to execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit configured to operate as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for dynamic feature value adjustments in a network application, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C #, Python, Objective-C, Visual Basic, .NET, HTML, CSS, SQL, NOSQL, Rust, Perl, etc. In some embodiments a compiler or interpreter is configured to convert the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 is configured to allow communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 are configured to couple the computing device 50 to a network. The network may include local area networks (LAN) as well as wide area networks (WAN) including, without limitation, Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 are configured to utilize one or more communication protocols. Examples of wired protocols may include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with interface elements representative of and/or incorporating the determined base feature values and/or incremental feature values. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device configured to receive position data identifying a latitude and longitude from one or more satellites of a GPS constellation. As another example, in some embodiments, the location device 68 is a cellular device configured to receive location data from one or more localized cellular towers. Based on the position data, the computing device 50 may determine a local geographical area (e.g., town, city, state, etc.) of its position.

In some embodiments, the computing device 50 is configured to implement one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

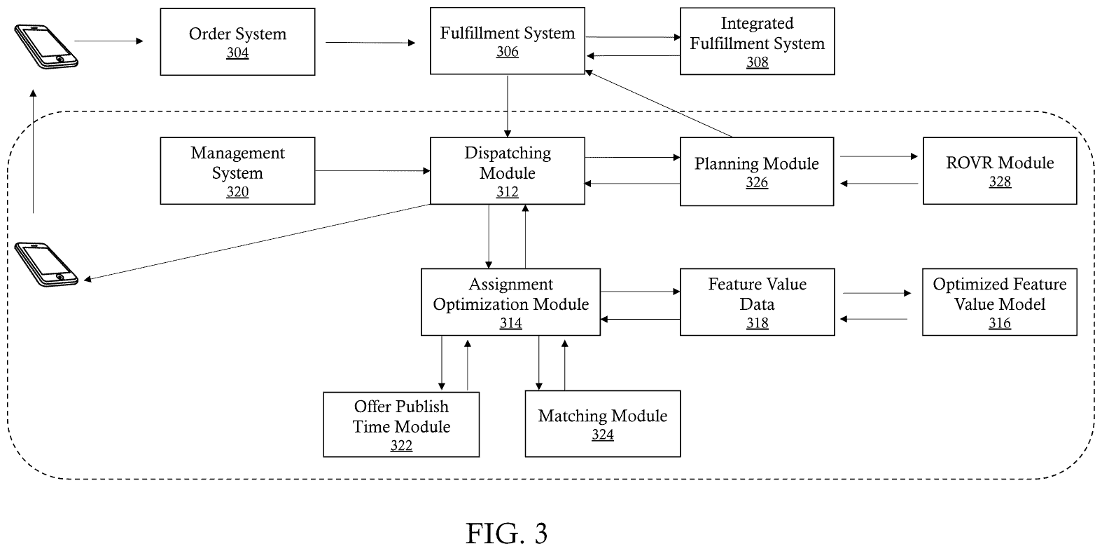

FIG. 3 is a flowchart illustrating a network application flow 300, in accordance with some embodiments. As illustrated in FIG. 3, a network application may include an order system configured to receive an input from a user device, such as user computing device 16, representative of a request for one or more services. For example, embodiments are discussed herein including a last mile delivery fulfillment network application, although it will be appreciated that any suitable network application may be configured to utilize dynamic feature values as discussed herein. In the context of a last mile delivery fulfillment network application, the input may include a request for delivery of one or more purchased items and/or services and may be provided to an order system 304.

The order system 304 may be in signal communication with a fulfillment system 306. The fulfillment system 306 may be configured to facilitate to completion of one or more requests represented by the user input, such as, for example, a delivery request for one or more items and/or services. The fulfillment system 306 may be in signal communication with a integrated fulfillment system 308 and a last mile delivery system 310. The integrated fulfillment system 308 may be configured to facilitate and/or manage order picking and staging at a location suitable for pickup by a last mile delivery service provider. The last mile delivery system 310 may be configured to facilitate matching of available delivery resources (e.g., available delivery drivers) and received orders.

In some embodiments, the last mile delivery system 310 includes a dispatching module 312 configured to coordinate available delivery resources. The dispatching module 312 may be configured to receive assignment information, such as time, trip, and/or offer price (e.g., feature value) information form an assignment optimization module 314. In some embodiments, the assignment optimization module 314 is configured to apply an escalating pricing process configured to incentivize selection of an available open request (e.g., trip) by one of an available set of resources (e.g., delivery drivers) by providing increasing pricing of the corresponding trip. In some embodiments, the escalating pricing includes a surge pricing model configured to present an offer (e.g., available trip) at a base starting price and configured to incrementally increase the base starting price in order to incentive selection of the corresponding trip by one of the plurality of available drivers. The base price may represent a best estimate of a lowest price at which a given trip will be accepted by a predetermined percentage of drivers.

In some embodiments, the last mile delivery system 310 is configured to apply an incentive pricing modification. Incentive pricing modifications may include specific price increases and/or payments provided to incentivize driver interaction with a platform at a specific time and/or location. For example, in some embodiments, incentive pricing modifications may include an additional incentive payment provided to drivers who accept and complete a predetermined number of trips during a predetermined time period (e.g., on a specific day). Although specific embodiments are discussed herein, it will be appreciated that any suitable incentive pricing options may be generated and/or applied by the last mile delivery system 310.

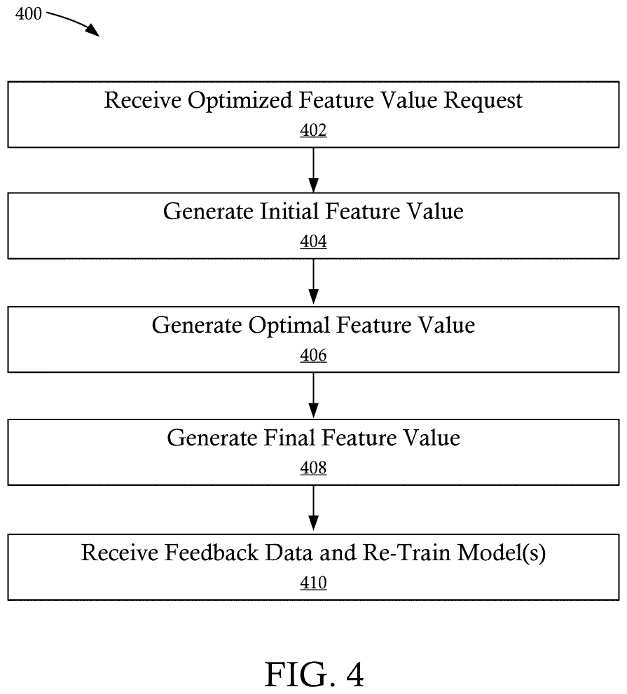

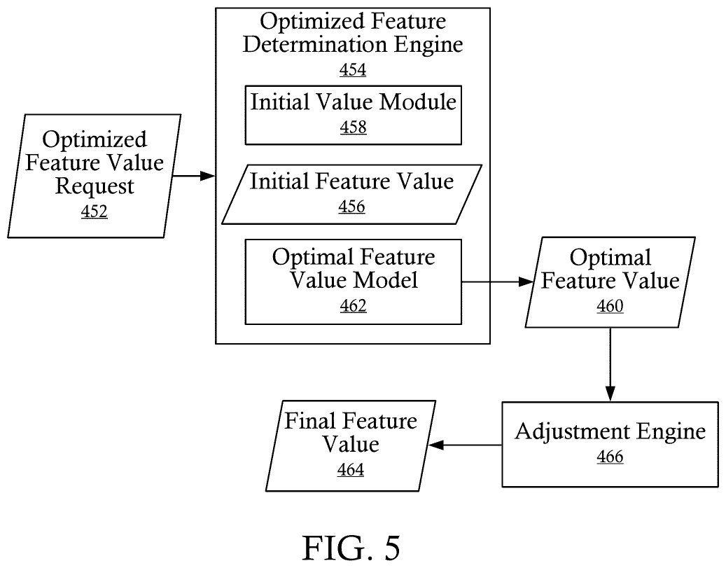

In some embodiments, the assignment optimization module 314 is configured to receive pricing feature value data 318 from an optimized feature value model 316 configured to apply an optimized feature value generation method 400 (e.g., as discussed in greater detail below with respect to FIGS. 4-5). The optimized feature value model 316 is configured to generate an optimized base feature value, e.g., a base price, and/or an incremental feature value, e.g., an increment for the base price. The optimized feature value model 316 may include a trained model, such as a trained optimization model, configured to generate a multiplier for a default base feature value based on one or more weights for an estimated supply elasticity for a corresponding time slot for delivery of one or more offers, as discussed in greater detail below.

In some embodiments, the last mile delivery system 310 includes a management system 320 configured to provide input for available users (e.g., drivers) for accepting and completing offers generated by the last mile delivery system 310. The assignment optimization module 314 may be in data communication with an offer publish time module 322 configured to determine time slot assignment for generated offers and/or a matching module 324 configured to provide matching between available drivers and one or more offers generated by the last mile delivery system 310. The last mile delivery system 310 may further include a planning module 326 and/or a resource optimization and vehicle routing module 328 for determining one or more parameters associated with each offer generated by the last mile delivery system 310, such as, for example, time slot assignment, trip distance, trip time, etc.

FIG. 4 is a flowchart illustrating an optimized feature value generation method 400, in accordance with some embodiments. FIG. 5 is a process flow 450 illustrating various steps of the optimized feature value generation method 400, in accordance with some embodiments. At step 402, an optimized feature value request 452 is received. The optimized feature value request 452 may be generated by any suitable system, engine, module, etc., such as, for example, an assignment optimization module 314 discussed above. In some embodiments, an optimized feature value request 452 may be generated periodically, for example, just prior to a start of a corresponding time slot for an offer configured to receive the optimized feature value. In one non-limiting example, an optimized feature value request 452 may be generated for offer within a time slot for a last mile delivery system prior to the corresponding time slot. The optimized feature value request 452 may be provided to any suitable system, engine, module, etc., such as, for example, a dynamic feature determination engine 454, such as, for example, the optimized feature value model 316.

At step 404, an initial feature (or template) value 456 is generated. The initial feature value 456 may be generated using any suitable algorithm, model, process, etc. For example, in some embodiments, the initial feature value 456 may be generated by an initial value module 458 implemented by and/or in conjunction with the dynamic feature determination engine 454. The initial value module 458 (and/or any other suitable module) may be configured to generate an initial feature value 456 based on one or more attributes associated with the corresponding feature and/or an object including the feature. In one non-limiting example, a feature value may include a pricing value for a trip object generated by and/or offered by a last mile delivery services and the one or more attributes may include attributes of the corresponding delivery request such as pickup location, delivery location, current number of offer objects, time slot, etc. Although specific embodiments are discussed herein, it will be appreciated that any suitable attributes may be used to generate an initial feature value 456.

At step 406, the initial feature value 456 is adjusted to generate an optimal feature value 460. The optimal feature value 460 may be generated by any suitable engine, module, system, etc., such as an optimal feature model 462 implemented by and/or in conjunction with the dynamic feature determination engine 454. In some embodiments, the optimal feature value 460 is generated by adjusting the initial feature value 456 to a minimum value that does not impact supply elasticity, e.g., a corresponding supply related to the feature and/or an object including the feature. For example, in the context of a last mile delivery system and a trip price feature value, the optimal feature value 460 may include the minimum acceptable pre-surge price for a corresponding trip that does not meaningfully decrease a relevant supply of drivers that will accept the trip at the corresponding optimized price feature value.

As one non-limiting example, in some embodiments, an initial feature value 456 for an offered trip through a last mile delivery system may be determined at a first value, such as, for example, $5.00. The initial feature value 456 may be above a minimum reservation value for a majority of platform users, e.g., a minimum pre-surge price at which a predetermined percentage of drivers will accept the offered trip. To continue the example, a minimum reservation price for a majority of drivers may be $4.00, below the $5.00 initial feature value for the corresponding trip. When the initial feature value 456 is above the minimum reservation value of the corresponding feature, the offer (e.g., trip) will be accepted without utilizing any surge pricing. However, in such instances, the offered trip is not optimized, as the offered feature value, e.g., $5.00, is higher than the value at which the corresponding trip would have been accepted by a majority of users of the network platform. In such instances, a downward adjustment of the feature value 456 is available without impacting the available supply of drivers (e.g., without impacting the supply elasticity).

In some embodiments, the optimal feature value 460 is selected to optimize one or more favorable downward pressure factors without causing a significant impact from unfavorable upward pressure factors with respect to the feature value. As one non-limiting example, in the context of a last mile delivery system, favorable downward pressure factors may include, but are not limited to, a surplus of available drivers, a minimum reservation price below a current initial price value, etc., and unfavorable upward pressure factors may include, but are not limited to, a minimum reservation price above a current price value for a predetermined percentage of available drivers, surge pricing increments, etc. In some embodiments, where supply (e.g., available drivers) is significantly higher as compared to a demand (e.g., available trips), supply to pre-surge acceptance is weakly (almost zero) correlated, providing for optimization of favorable downward pressure factors, e.g., a reduction in the optimal feature value 456, such as a reduction in base price.

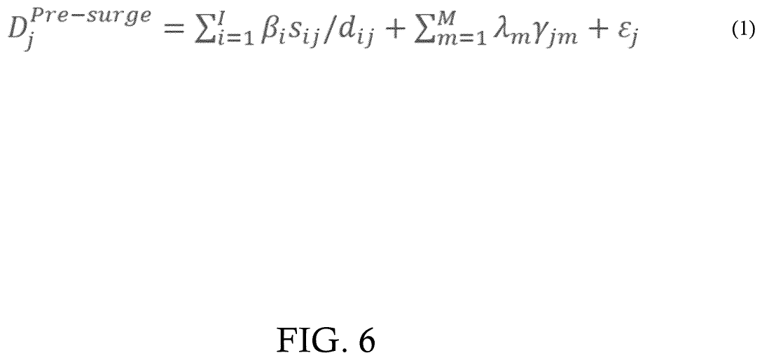

In some embodiments, an optimal feature value 460 is generated by an optimal feature model 462 including at least one weight representative of a relationship between a relevant supply and a pre-surge acceptance rate. In some embodiments, one or more weights, β, of the optimal feature model 462 is generated by a logistic regression process. For example, a logistic regression may be applied according to equation (1) in FIG. 6. For each offer (e.g., each trip in a last mile delivery service),

$${D}_{j}^{pre - surge}$$

has a first predetermined value, e.g.,

$${D}_{j}^{p r e - s u r g e} = 1 ,$$

when the corresponding offer is accepted prior to a surge price adjustment being applied (e.g., pre-surge acceptance or PSA), and has a second predetermined value, e.g.,

$${D}_{j}^{p r e - s u r g e} = 0 ,$$

otherwise. In equation (1),

$${D}_{j}^{pre - surge}$$

is equal to a demand over supply ratio, where i is a slot (e.g., a time slot such as one hour time intervals). sⱼ is the supply during the time slot i of offer j, dⱼ is the demand during the time slot i of offer j, γⱼₘ is an attribute m for offer j where m consists of offer parameters (e.g., an estimated distance and number of offers for a last mile delivery system), and λₘ represents the coefficients on attribute γₘ. In some embodiments, λₘ and γⱼₘ may be omitted when determining weights (e.g., may be used to subsume effects of attributes on the left hand side variable D. In some embodiments, the weights, 1/β, are highly correlated with slots having misvalued (e.g., overvalued) feature values, for example, a mispriced trip. In some embodiments, the amount of adjustment of a feature value to generate an optimized feature value 456 is greater when 1/β is high and lower when 1/β is low. In some embodiments, the use of a logistic regression process allows for control of additional factors, such as estimated distance and/or number of offers for a given slot.

In some embodiments, the optimal feature model 462 applies an average reduction goal configured to apply an average reduction amount over a set of offers (e.g., trips) for a selected portion of the available offers. For example, in the context of a last mile delivery system, the average reduction goal may include an average price reduction for a set of offers within a predefined geographic area (e.g., a regional reduction goal). A set of offer-specific reductions are applied to each offer in a set of offers for a predetermined time period. The offer-specific reduction applied to each of the offers may be different, such that certain offers receive a larger or smaller feature value adjustment with respect to other offers in the set of offers and/or the average reduction goal. The offer-specific reductions are selected such that, when averaged, the offer-specific reductions are equal to the average reduction goal.

In some embodiments, the optimal feature model 462 is configured to generate a multiplier for each offer within each slot. For example, the optimal feature model 462 may be configured to apply a first multiplier to a first slot, a second multiplier to a second slot, a third multiplier to a third slot, etc. The multiplier may be applied to each offer within a slot and/or may be determined individually for each offer. As one non-limiting example, in some embodiments, a multiplier for each offer and/or slot may be a value between 0 and 1, although it will be appreciated that any suitable multiplier values may be applied.

In some embodiments, the multiplier is determined by the optimal feature model 462 utilizing the predetermined weights, e.g., 1/β, and one or more trained layers generated by a two-layer training process. The two-layer training process may include a first layer configured to generate one or more parameters and a second layer configured to determine a multiplier value for each slot and/or offer. The first layer may be configured to obtain and/or generate one or more parameters such as one or more weights for each slot/offer (e.g., the weights 1/β discussed above), determine and/or set an average base price reduction goal (e.g., as discussed above), forecast an expected number of offers for each slot, forecast an expected average base price for each slot, and/or determine a switchback variant for each set-slot pairing (e.g., each predetermined set of offers for each slot during a corresponding time period, such as each set-date-slot grouping). The forecasting for a number of offers per slot and/or expected average base price for each slot may be performed according to one or more known forecasting processes. In some embodiments, a switchback variant is assigned based on switchback experimentation assigning a random value for each slot-time period and defining an average treatment effect as mean metrics for treatment.

In some embodiments, a switchback variant is configured to classify a trip into one of a treatment or control group. For example, switchback variants may be used to assess the impact of one or more modifications through experimentation. Modified logic may be applied to a set of trips classified as treatments and current logic may be applied to a set of trips classified as a control group. Deployment of modified logic may be determined based on the outcomes of the experiment. A switchback variant may randomly select a treatment or a control for each slot (e.g., date-hour slot) and apply the corresponding logic for all trips within the given slot. Although switchback variants are discussed herein, it will be appreciated that any suitable variation may be used to confirm, validate, and/or otherwise control deployment of updated logic.

In some embodiments, the second layer training process of the two-layer training process is configured to configure a multiplier generation process. The multiplier generation process may be configured to iteratively and/or incrementally generate multiplier values. For example, in some embodiments, the multiplier generation process may be configured to receive an input including an average price reduction goal, a set of weights (wₛ), a forecast volume (vₛ) for a predetermined forecast period, and a mean base price (pₛ) for each slot s. As one non-limiting example, where each slot is representative of an hour period in a day, the slot s∈{0, . . . , 24}. A count may be initialized to zero, a set of multipliers (mₛ) may be initialized to a value of 1 for all s, and adjusted base price initialized as

$${p}_{s}^{adj} = {p}_{s}$$

for all s. The process may be configured to perform steps including:

While count≤max_iteration
Update adjusted prices

$${p}_{s}^{adj} = {p}_{s} \cdot {m}_{s}$$

for all s;
Check if a price reduction goal is met: If

$$\frac{1}{\sum {v}_{s}} \sum {p}_{s}^{adj} {v}_{s} \leq \frac{1}{\sum {v}_{s}} \sum {p}_{s} {v}_{s} - goal ,$$

return mₛ;
Update multipliers:

$${m}_{s} = {m}_{s} - \frac{{w}_{s}}{1000}$$

for all s if mₛ>0.95;
Increment count: count+=1
   The count variable sets an upper limit on the number of iterations for the multiplier loop. One or more of the multiplier values is iteratively adjusted from a starting value of 1 to a value less than 1 until the reduction goal is met. In the above example, a lower limit of 0.95 is established for each multiplier such that a multiplier cannot be reduced below that value. The optimal feature value 456 may be output for use in one or more subsequent operations, as discussed herein.

In some embodiments, at optional step 408, one or more additional adjustments may be applied to an optimal feature value 460 to generate a final feature value 464. One or more adjustments and/or adjustment processes may be applied by any suitable engine, system, module, etc., such as, for example, an adjustment engine 466. For example, in some embodiments, a nearest increment process may be applied to adjust an optimal feature value 460 to a nearest one of a set of predetermined feature increments, such as predetermined price increments. As one non-limiting example, if an optimal feature value for a pricing feature is determined to be $6.97 at step 406, a smoothing process may be applied to increase the price to a predetermined increment, e.g., a whole dollar increment such as $7.00. As another example, a capping process may be applied to increase a feature value to a predetermined minimum value for certain offers and/or slots. As one non-limiting example, if an optimal feature value 460 for a pricing feature is determined to be $5.96, a capping process may be implemented to increase the price to a predetermined minimum value, e.g., $6.00.

The disclosed systems and methods provide an improvement to feature value generation without significantly impacting certain metrics associated with operation of a system. For example, in the context of a last mile delivery system, the disclosed systems and methods provide for decreased pre-surge pricing (e.g., a decrease in base price of offers) without a statistically significant impact on pre-surge acceptance, on time delivery, and/or other last mile delivery metrics.

In some embodiments, one or more feedback elements may be received and utilized to modify one or more models and/or processes of the disclosed systems and methods. For example, at optional step 410, a set of feedback data including pre-surge acceptance rate and user feedback is received. User feedback may include, but is not limited to, quantifiable and/or qualitative feedback regarding user interactions with a system, such as driver feedback regarding interactions with a last mile delivery platform. The feedback data may include direct feedback (e.g., acceptance rates, direct user feedback, etc.) and/or indirect feedback (driver attrition/churn rates, overall driver interaction rates, etc.). The feedback data may be converted into training data, e.g., quantized, normalized, etc. and provided to a model training and/or retraining process, for example as discussed in greater detail below, to generate and/or retrain one or more models, such as, for example, one or more optimal feature models 462.

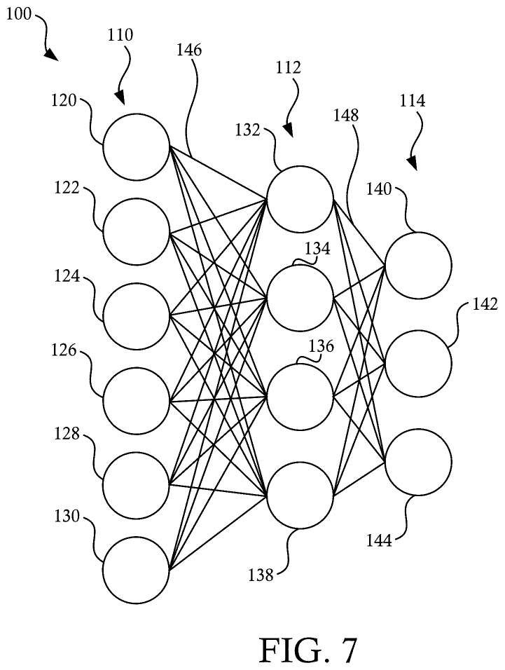

FIG. 7 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 7 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 may be arranged in layers 110-114, wherein the layers may comprise an intrinsic order introduced by the edges 146-148 between the nodes 120-144 such that edges 146-148 exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 may be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number may be assigned as a value to every node 120-144 of the neural network 100. Here,

$${x}_{i}^{( n )}$$

denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 may comprise a weight being a real number, in particular, the weight is a real number within the interval [−1, 1], within the interval [0, 1], and/or within any other suitable interval. Here,

$${w}_{i , j}^{( m , n )}$$

denotes the weight of the edge between the i-th node 120-138 of the m-th layer 110, 112 and the j-th node 132-144 of the n-th layer 112, 114. Furthermore, the abbreviation

$${w}_{i , j}^{( n )}$$

is defined for the weight

$${w}_{i , j}^{( n , n + 1 )} .$$

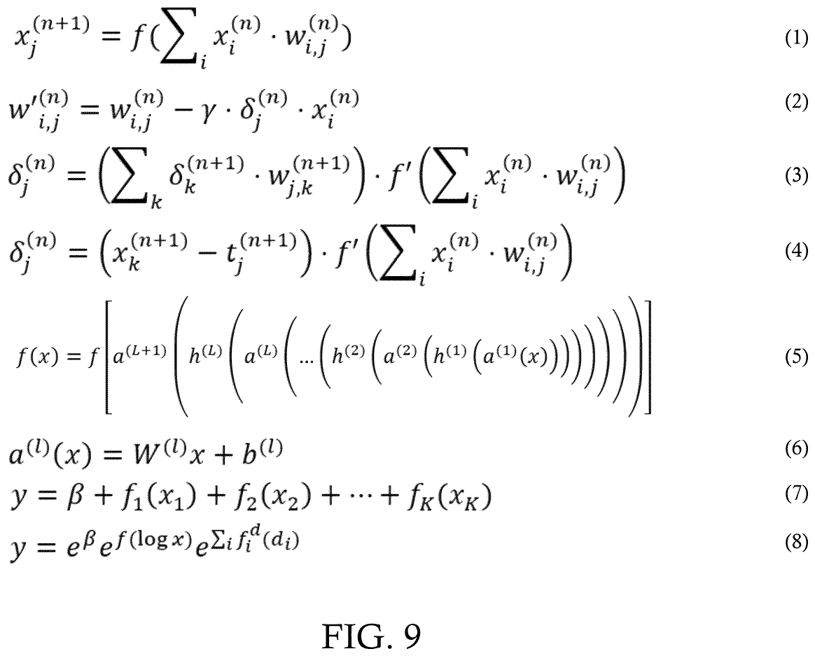

In particular, to calculate the output values of the neural network 100, the input values are propagated through the neural network. In particular, the values of the nodes 132-144 of the (n+1)-th layer 112, 114 may be calculated based on the values of the nodes 120-138 of the n-th layer 110, 112 by equation (1) of FIG. 9.

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 may be calculated based on the values of the input layer 110 of the neural network and/or based on the values of a prior hidden layer, etc.

In order to set the values

$${w}_{i , j}^{( m , n )}$$

for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to equation (2) of FIG. 9, wherein γ is a learning rate, and the numbers

$${δ}_{j}^{( n )}$$

may pe recursively calculated as equation (3) in FIG. 9 based on

$${δ}_{j}^{( n + 1 )} ,$$

if the (n+1)-th layer is not the output layer and equation (4) in FIG. 9 if the (n+1)-th layer is the output layer 114, wherein f′ is the first derivative of the activation function, and

$${y}_{j}^{( n + 1 )}$$

is the comparison training value for the j-th node of the output layer 114.

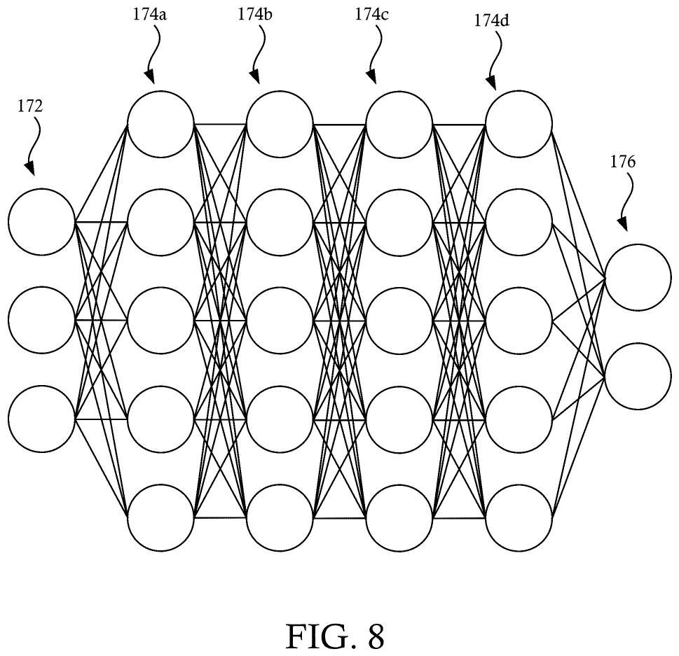

FIG. 8 illustrates a deep neural network (DNN) 170, in accordance with some embodiments. The DNN 170 is an artificial neural network, such as the neural network 100 illustrated in conjunction with FIG. 7, that includes representation learning. The DNN 170 may include an unbounded number of (e.g., two or more) intermediate layers 174a-174d each of a bounded size (e.g., having a predetermined number of nodes), providing for practical application and optimized implementation of a universal classifier. Each of the layers 174a-174d may be heterogenous. The DNN 170 may be configured to model complex, non-linear relationships. Intermediate layers, such as intermediate layer 174c, may provide compositions of features from lower layers, such as layers 174a, 174b, providing for modeling of complex data.

In some embodiments, the DNN 170 may be considered a stacked neural network including multiple layers each configured to execute one or more computations. The computation for a network with L hidden layers may be denoted as equation (5) in FIG. 9, where a^{(l)}(x) is a preactivation function and h^{(l)}(x) is a hidden-layer activation function providing the output of each hidden layer. The preactivation function a^{(l)}(x) may include a linear operation with matrix W^{(l)} and bias b^{(l)}, as defined by equation (6) in FIG. 9.

In some embodiments, the DNN 170 is a feedforward network in which data flows from an input layer 172 to an output layer 176 without looping back through any layers. In some embodiments, the DNN 170 may include a backpropagation network in which the output of at least one hidden layer is provided, e.g., propagated, to a prior hidden layer. The DNN 170 may include any suitable neural network, such as a self-organizing neural network, a recurrent neural network, a convolutional neural network, a modular neural network, and/or any other suitable neural network.

In some embodiments, a DNN 170 may include a neural additive model (NAM). An NAM includes a linear combination of networks, each of which attends to (e.g., provides a calculation regarding) a single input feature. For example, a NAM may be represented as equation (7) in FIG. 9, where β is an offset and each fᵢ is parametrized by a neural network. In some embodiments, the DNN 170 may include a neural multiplicative model (NMM), including a multiplicative form for the NAM mode using a log transformation of the dependent variable y and the independent variable x defined in equation (8) of FIG. 9, where d represents one or more features of the independent variable x.

Identification of optimal feature values associated with network platforms can be burdensome and time consuming for platform operators, especially when changes to certain feature values result in undesirable upward pressures. Systems including trained optimal feature models, as disclosed herein, significantly reduce this problem, allowing platform operators to generate interface elements that include optimized feature values. For example, in some embodiments described herein, when a platform user is presented with an interface element including an optimized feature value, each interface element includes, or is in the form of, a link to an interface page for accepting or otherwise interacting with a corresponding offer. Beneficially, programmatically identifying optimal feature values and presenting a user with offer interfaces including optimized feature values may improve the speed of the user's interactions with an electronic interface.

It will be appreciated that determination of optimal feature values, as disclosed herein, particularly on large datasets or in a timely manner intended to be used large network platforms, is only possible with the aid of computer-assisted machine-learning algorithms and techniques, such as trained optimal feature models. In some embodiments, machine learning processes including trained models are used to perform operations that cannot practically be performed by a human, either mentally or with assistance, such as optimization of feature values using a model trained via a two-layer training process. It will be appreciated that a variety of machine learning techniques can be used alone or in combination to generate trained optimal feature models and/or optimized feature values.

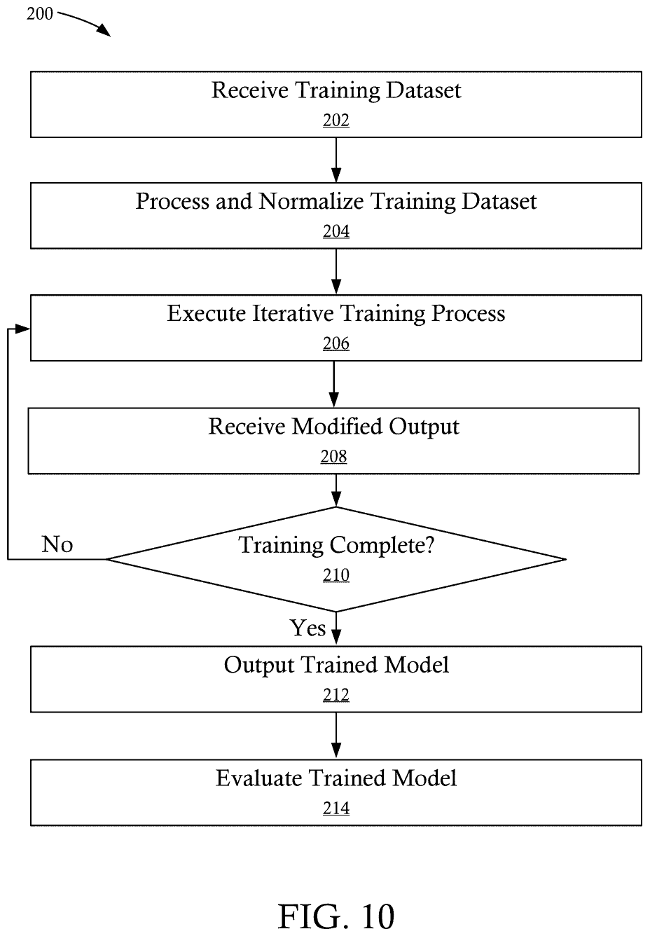

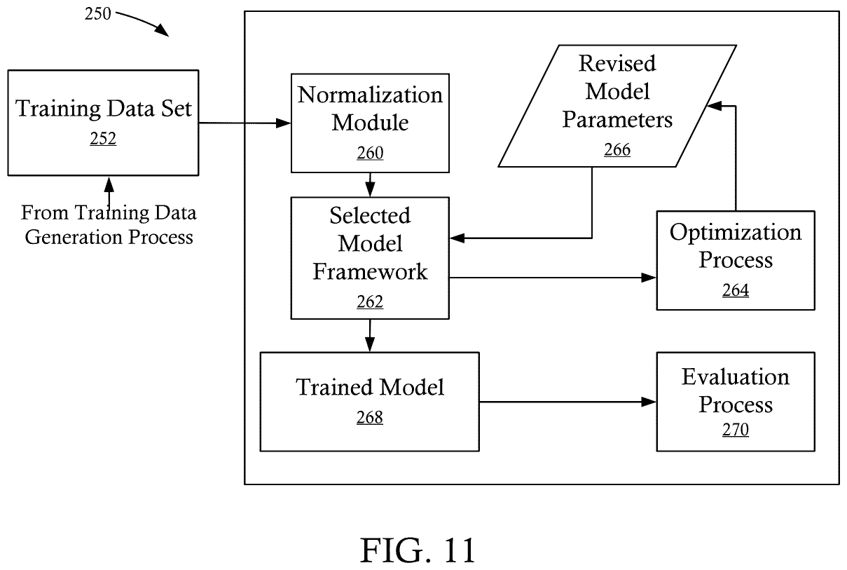

In some embodiments, a trained optimal feature model can include and/or implement one or more trained models. In some embodiments, one or more trained models can be generated using an iterative training process based on a training dataset. FIG. 10 illustrates a method 200 for generating a trained model, such as a trained optimal feature model, in accordance with some embodiments. FIG. 11 is a process flow 250 illustrating various steps of the method 200 of generating a trained model, in accordance with some embodiments. At step 202, a training dataset 252 is received by a system, such as a processing device 10. The training dataset 252 can include labeled and/or unlabeled data.

At optional step 204, the received training dataset 252 is processed and/or normalized by a normalization module 260. For example, in some embodiments, the training dataset 252 can be augmented by imputing or estimating missing values of one or more features associated with feature value inputs. In some embodiments, processing of the received training dataset 252 includes outlier detection configured to remove data likely to skew training of an optimal feature model. In some embodiments, processing of the received training dataset 252 includes removing features that have limited value with respect to training of the optimal feature model.

At step 206, an iterative training process is executed to train a selected model framework 262 and, at step 208, a modified framework output is generated. The selected model framework 262 can include an untrained (e.g., base) machine learning model and/or a partially or previously trained model (e.g., a prior version of a trained model). The training process is configured to iteratively adjust parameters (e.g., hyperparameters) of the selected model framework 262 to minimize a cost value (e.g., an output of a cost function) for the selected model framework 262.

The training process is an iterative process that generates set of revised model parameters 266 during each iteration. The set of revised model parameters 266 can be generated by applying an optimization process 264 to the cost function of the selected model framework 262. The optimization process 264 can be configured to reduce the cost value (e.g., reduce the output of the cost function) at each step by adjusting one or more parameters during each iteration of the training process.

After each iteration of the training process, at step 210, a determination is made whether the training process is complete. The determination at step 210 can be based on any suitable parameters. For example, in some embodiments, a training process can complete after a predetermined number of iterations. As another example, in some embodiments, a training process can complete when it is determined that the cost function of the selected model framework 262 has reached a minimum, such as a local minimum and/or a global minimum.

At step 212, a trained model 268, such as a trained optimal feature model, is output and provided for use in a one or more network platforms, such as a last mile delivery platform as discussed herein. At optional step 214, a trained model 268 can be evaluated by an evaluation process 270. A trained model can be evaluated based on any suitable metrics, such as, for example, an F or F1 score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of exemplary embodiments, it is not limited thereto. Rather, the appended claims should be construed broadly, to include other variants and embodiments, which may be made by those skilled in the art.

What is claimed is:

1. A system, comprising:
a non-transitory memory;
a processor communicatively coupled to the non-transitory memory, wherein the processor is configured to read a set of instructions to:
generate a set of weights for at least one offer associated with a network application;
obtain a feature reduction goal for a first feature;
receive a base feature value of the first feature for the at least one offer;
apply a trained optimized feature value model to determine a feature adjustment for the base feature value based at least in part on the feature reduction goal, wherein the feature adjustment and the feature reduction goal are different;
apply the feature adjustment to the base feature value to generate an optimized feature value; and
transmit the offer including the optimized feature value to at least one user device.

2. The system of claim 1, wherein the at least one offer is a first offer of a plurality of offers, and wherein an average of an offer-specific feature adjustment of each of the plurality of offers is equal to the feature reduction goal.

3. The system of claim 2, wherein the plurality of offers are grouped into a plurality of sets, and wherein the offer-specific feature adjustment of each offer includes a set adjustment applied to each offer in a corresponding one of the plurality of sets.

4. The system of claim 1, wherein the plurality of sets comprise a plurality of time slots.

5. The system of claim 1, wherein the trained optimized feature value model comprises a first layer configured to obtain a plurality of parameters and a second layer configured to generate the feature adjustment based at least in part on the plurality of parameters.

6. The system of claim 5, wherein the feature adjustment comprises a multiplier value.

7. The system of claim 1, wherein the network application comprises a last mile delivery system, and wherein the optimized feature value comprises a base trip value.

8. The system of claim 1, wherein the set of weights are generated by applying a logistic regression process.

9. A computer-implemented method, comprising:
generating a set of weights for at least one offer associated with a network application;
obtaining a feature reduction goal for a first feature;
receiving a base feature value of the first feature for the at least one offer;
applying a trained optimized feature value model to determine a feature adjustment for the base feature value based at least in part on the feature reduction goal, wherein the feature adjustment and the feature reduction goal are different;
applying the feature adjustment to the base feature value to generate an optimized feature value; and
transmitting the offer including the optimized feature value to at least one user device.

10. The computer-implemented method of claim 9, wherein the at least one offer is a first offer of a plurality of offers, and wherein an average of an offer-specific feature adjustment of each of the plurality of offers is equal to the feature reduction goal.

11. The computer-implemented method of claim 10, wherein the plurality of offers are grouped into a plurality of sets, and wherein the offer-specific feature adjustment of each offer includes a set adjustment applied to each offer in a corresponding one of the plurality of sets.

12. The computer-implemented method of claim 9, wherein the plurality of sets comprise a plurality of time slots.

13. The computer-implemented method of claim 9, wherein the trained optimized feature value model comprises a first layer configured to obtain a plurality of parameters and a second layer configured to generate the feature adjustment based at least in part on the plurality of parameters.

14. The computer-implemented method of claim 13, wherein the feature adjustment comprises a multiplier value.

15. The computer-implemented method of claim 9, wherein the network application comprises a last mile delivery system, and wherein the optimized feature value comprises a base trip value.

16. The computer-implemented method of claim 9, wherein the set of weights are generated by applying a logistic regression process.

17. A non-transitory computer readable medium having instructions stored thereon, wherein the instructions, when executed by at least one processor, cause at least one device to perform operations comprising:
generating a set of weights for a first offer in a plurality of offers associated with a network application;
obtaining a feature reduction goal for a first feature;
receiving a base feature value of the first feature for the first offer;
applying a trained optimized feature value model to determine a feature adjustment for the base feature value based at least in part on the feature reduction goal, wherein an average of the feature adjustment for each offer in the plurality of offers is equal to the feature reduction goal;
applying the feature adjustment to the base feature value to generate an optimized feature value; and
transmitting the offer including the optimized feature value to at least one user device.

18. The non-transitory computer readable medium of claim 17, wherein the at least one offer is a first offer of a plurality of offers, wherein an average of an offer-specific feature adjustment of each of the plurality of offers is equal to the feature reduction goal, wherein the plurality of offers are grouped into a plurality of sets, and wherein the offer-specific feature adjustment of each offer includes a set adjustment applied to each offer in a corresponding one of the plurality of sets.

19. The non-transitory computer readable medium of claim 17, wherein the plurality of sets comprise a plurality of time slots.

20. The non-transitory computer readable medium of claim 17, wherein the trained optimized feature value model comprises a first layer configured to obtain a plurality of parameters and a second layer configured to generate the feature adjustment based at least in part on the plurality of parameters, and wherein the feature adjustment comprises a multiplier value.
